(19) United States
(12) Patent Application Publication
(10) Pub. No.: US 2013/0067906 A1
(43) Pub. Date: Mar. 21, 2013

(54) HEAT EXCHANGING CYLINDER HEAD

(71) Applicant: Bernard Gilbert Macarez, Lasseube (FR)

(72) Inventor: Bernard Gilbert Macarez, Lasseube (FR)

(21) Appl. No.: 13/701,902

(22) PCT Filed: May 30, 2011
(86) PCT No.: PCT/FR11/00320

§ 371 Date: Dec. 4, 2012

(30) Foreign Application Priority Data
Jun. 11, 2010 (FR) 1002471

(51) Int. Cl. F02G 1/055; F02G 1/02

(52) U.S. Cl. CPC F02G 1/055; F02G 1/02
USPC 60/517; 60/508

(57) ABSTRACT

This engine (1) (of the piston engine or rotary Wankel-type engine type) includes a heat-exchanging cylinder head (2) which transfers to the fluid internal to the engine the heat energy collected from an external hot source (liquid, gaseous or by radiation). In a closed or open cycle it uses a gaseous fluid (air) or a refrigerant such as an engine fluid in particular when the temperature of the hot source is low. The volumetric compression ratio of the engine is optimized according to the temperature level of the hot source in order on the one hand to allow the internal heat exchanging cylinder head (2) and (9) to be positioned in the dead volume freed inside the chamber (piston top dead center) of the engine (1) and on the other hand to extract significant mechanical work. It is a matter of increasing technological feasibility at the expense of an acceptable loss in efficiency given that the contribution from the hot source is free of charge. It avoids the adding of a bulky external heat exchanger and the associated problems of the thermal and mechanical stresses thereof and also makes it possible to reduce the flow rate of the engine fluid (for example air) transferred to a strict minimum. By comparison with competing systems, this invention does not require the engine fluid to be transferred to the hot source and vice-versa and there are therefore no additional valves and the engine air flow rate is minimum. It is a relatively inexpensive invention particularly suited to the field of the recovery of free or wasted heat (exchange with a hot external fluid—exhaust gas or radiation) where other technological solutions with a higher overall efficiency are either technologically unfeasible or require too great an investment thereby jeopardizing their economic model

### BACKGROUND

This invention relates to a thermal engine (piston or rotary Wankel type) of which the heat energy supply is from an external heat source that can be a hot fluid or radiation. It is the application of similar cycles such as cycles of Stirling or Ericsson.

To produce mechanical energy, this engine operates with an open or closed cycle. The fluid is compressible in the operating conditions of the engine and rejects heat from the exhaust to a cold source of any type whatsoever (fluid or solid) with or without using an external cooling exchanger depending on whether it is an open or closed cycle. The engine working fluid may be a refrigerant or a gas such as air, or any fluid capable of exchanging heat in the conditions of engine operation.

This engine is characterized in that it includes a heat exchanging cylinder head which transfers heat to the engine working fluid by conduction through the material of the cylinder head itself, the heat energy being collected from the fluid heat source external to the engine (liquid or gaseous) or from external heat radiation. Any form of heat recovery from a heat source can be used
from a concentrator of sunlight,
from the heat recovery of an exhaust gas piston engine or an exhaust gas turbine cycle
from a thermal heat source
from the heat recovery at the exhaust of a steam turbine.
any heat source capable of exchanging heat with the heat exchanging cylinder head.

The operation of this engine is not limited to aerobic area, but it can use refrigerant fluids as an engine working fluid especially when the temperature of the heat source is low.

Possible applications are for terrestrial, maritime, air or space domains.

The application of the Stirling cycle, Rankine or Hirn cycle to a piston engine is not new and many patents (U.S. Pat. No. 3,180,078, U.S. Pat. No. 4,121,423, DE 101 43 342 081 499 GB1 and more recently WO 2008/031939) proposed to use an external heat source such as energy input. Other patents (U.S. Pat. No. 4,514,979 A (ERNST MOHR), DE 22 00 842 A1 (ILG FRITZ), WO 2009/066178 A2 (CAD Yding U.S.) also offer heat recovery systems.

However, most of these patents encountered the following problems:
Either they used a independent heat exchanger located outside and not attached to the engine chamber DE 22 00 842 A1 (ILG FRITZ) Jul. 12, 1973 to recover heat from the heat source,
   And the large volume of the exchanger (equivalent to 500 or 1000 times the dead volume of the cylinder) required first an initial pressure inflating of the heat exchanger hence the need to spend large initial mechanical energy incompatible with conventional systems starts (big capacity starters and big battery).
   In addition, a large flow of air was transferred through the external heat exchanger, while only a small amount of air that would be useful to produce mechanical energy in the cylinder. It was therefore necessary to collect a significant energy from engine cycle only to compensate for the work of the air transfer non-producing mechanical energy.
   The transfer of heat energy collected was done the piston at top dead center during times extremely small (a few milliseconds depending on the engine revolution per minute). This heat transfer was done by transferring warm airflow from the external heat exchanger inside the dead volume of the cylinder. This required on one hand, the addition of large sized specific valves (in addition to those used for air intake and exhaust) to allow the transfer of this heated airflow but on the other hand, the openings and closures of these valves must be carried out at an elevated pressure as the piston is at top dead center. These high pressures and the tubes used to transfer the airflow generated many leaks.
   Finally, the size of the heat exchanger was incompatible with engine high pressure due to the mechanical stress caused by the pressure differential inside outside this exchanger. The levels of thermal and mechanical stress were similar to those encountered in the conventional cylinder heads but with volumes and surfaces of the external heat exchanger much more important.
Either they used a heat exchanger located inside the engine (patent GB1081499, U.S. Pat. No. 4,514,979 A (ERNST MOHR) May 7, 1985, WO 2009/066178 A2 (CAD Yding U.S.) May 28, 2009). However the channels or tubes of calorie intake and calorie extraction are both located within the cylinder chamber of the air motor. The dimensions required for the two types of tubes (those for calorie intake to the engine working fluid and those to extract calorie from hot source) were not compatible with the size of the dead volume of the chamber when the piston is top dead center. This system leads to:
   Either to tubes sizes too small thus creating high-pressure losses drop and against-pressure at the exhaust of the other cylinders, which burden the expansion ratio of the conventional cylinders.
   Either the tubes were properly sized, so the dead volume in the cylinder chamber then became too small to place these tubes or leading to a engine compression ratio too high compatible with the temperature level of the heat source.

It is the exact location at which occurs the heat exchange between the fluid from the heat source and the engine working fluid, which characterizes the invention. The word “exchange” is expressed here as the exact location where the heat flow is transferred by conduction through the material on one side of a wall (bathed in the hot fluid source) to the other side of that wall (bathed by the working fluid). As shown in FIG. 12 there are three design types A, B, C. The innovative nature of this invention (type C) is to use the material of the cylinder head itself, to transfer heat by conduction from the hot source to the engine working fluid. This design avoids the transfer of fluid from the heat source in the “dead volume” of the cylinder where is the working fluid, or avoids adding additional valves, if the transfer is from the engine working fluid in the fluid of the hot source. One wins a space in the “dead volume” of the cylinder, which allows increasing the wall exchange surface with the working fluid on the one hand and on the other hand allows to keep an engine compression ratio ε is consistent with the low temperature of the heat source.

The invention proposed here can solve these problems
Using one hand to the heat exchanging cylinder head 2 that includes the external heat exchanger 11 into contact with the fluid heat source located outside the “dead volume” but integrally part of heat exchanging cylinder head 2 and the engine chamber, and the internal heat exchanger 9 in contact with the fluid located inside the “dead volume” of this chamber. The two heat exchangers 11 and 9 may be the assembly of several parts, such as shown in FIG. 8. The piece 10 is used as a conductor of heat between the part 11 and part 9. The two exchangers 9 and 11 may also be a single piece (parts 9.10 and 11 thus form a single piece the heat exchanging cylinder head 2. In the following text, we call this set of parts 9.10 and 11 the heat exchanging cylinder head 2 as shown in FIG. 7. Cette conception allows for thermal and mechanical stresses in the heat exchanging cylinder head 2 similar to those encountered in the cylinder heads of other conventional engines. It also reduces the mass of air transferred during the heat exchange to a minimum.
And in the other hand, by optimizing the compression ratio of the engine with the temperature level of the heat source. The energy recovered or exchanged from the hot source being free, one reduces the compression ratio to a level low enough to release a fairly large dead volume when the piston is top dead center to place the heat exchanger 9. The compression ratio of the engine, which is not the point of the best performance, will still be high enough to extract a significant mechanical energy. This is to increase the technological feasibility at the expense of a loss of acceptable performance given the free contribution of the heat source.

### Study Cycles

Studies cycles and the diagram in FIG. 1 shows that the influence of the compression ratio versus the engine performance cycle or mechanical energy extractable is even less important than the relative temperature T4/To (hot source/cold source) is low. There is therefore an optimum compression ratio for each heat source temperature. In other words, if the heat from the hot source is free it is possible to extract useful work from a cycle by changing the design of the engine in order to allow the capture and transfer of heat from this heat source to the engine working fluid through heat exchanging cylinder head. This invention proposes to reduce the compression ratio of the engine to a level low enough to allow one hand to produce useful work and secondly to allow placing a heat exchanging cylinder head 2 with an internal heat exchanger 9 directly placed in the released dead volume in the cylinder when the piston is top dead center.

Preliminary heat exchanger calculations, air cylinder side wall (using law of Woschni) show that it is possible to size a heat exchanger 9 internal in the cylinder whose surfaces area and volume of exchange of the walls are consistent with one hand the dead volume available (piston top dead center) and on the other hand, the compression ratio of the engine cycle.

The engine cycle is conventional 2-stroke or 4 stroke. The heat input to the working fluid is continuously through the heat exchanging cylinder head 2 during the piston compression and expansion phases. The initial input of heat being free, we look first to increase the exchange surface the heat exchanging cylinder head 2 as shown on part 9 FIGS. 4 and 5 while sizing a dead volume that is consistent with the engine compression ratio of the engine selected.

Although this invention can be applied to any type of piston engine or rotary Wankel and various type of application can be found depending on the nature of the heat source available (radiation or gas exchange) we restrict ourselves in this following description of the conventional piston engine to facilitate understanding.

### DRAWINGS

FIG. 1 is a diagram illustrating the maximum extractable energy versus the engine compression ratio for 3 ratios T4/To (temperature of the heat source (T4) and To temperature of the cold source given as an example).

FIG. 2 is an example of ¾ of a conventional piston engine 1 showing a heat exchanging cylinder head 2.

FIG. 3 is a sectional view of a 2-stroke engine with a heat exchanging cylinder head 2.

FIG. 4 is a sectional view of a 4-stroke engine with a heat exchanging cylinder head 2 and side valves 5 and 6.

FIG. 5 is a sectional view of a 2-stroke engine with a heat exchanging cylinder head 2, of which the exchange surface was increased.

FIG. 6 is a sectional view of a rotary engine (Wankel) equipped with a heat exchanging cylinder head 2 suitable for this type of engine.

FIG. 7 is a sectional view of a heat exchanging cylinder head 2 that may—be one single part but represented here consisting of 3 elements 9,10 and 11

FIG. 8 is a sectional view along BB of the control system of the engine 1 performed in this example by obstructing the passage of hot fluid from the hot source

FIG. 9 is a top view of the DD system shown in FIG. 8.

FIG. 10 is a cross sectional view along AA or CC system shown in FIG. 8.

FIG. 11 is a schematic view of an installation using solar radiation as a heat source 22 and the position of the cooler 19 located in the flow of a river 20 or buried in the ground 20 as cold source as an example.

FIG. 12 shows the different types A, B, C exchanger design possible.

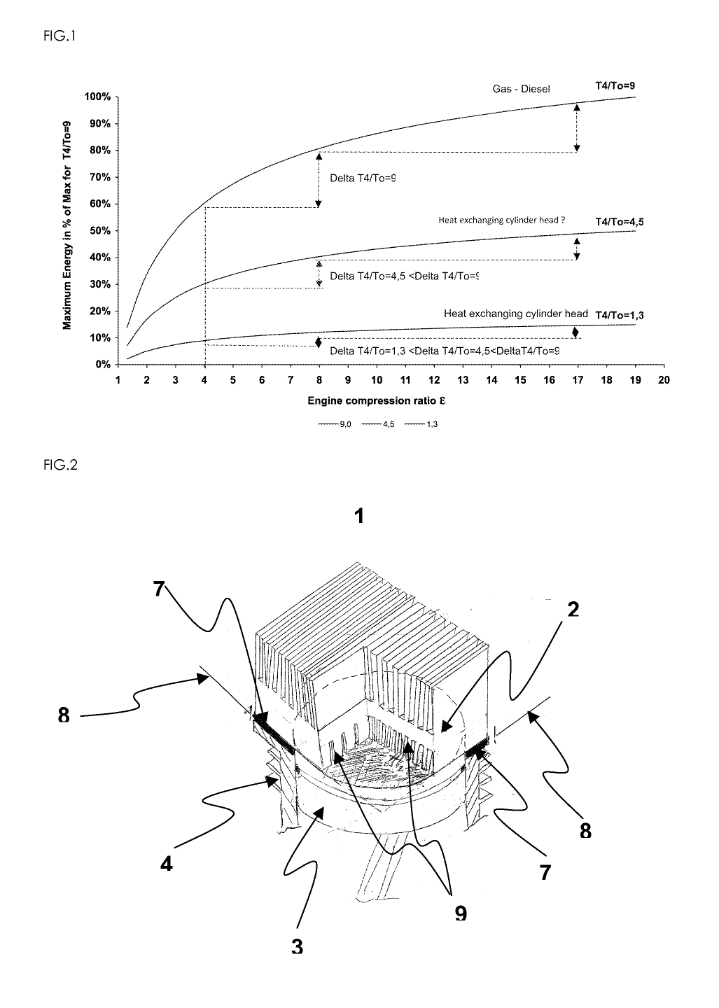

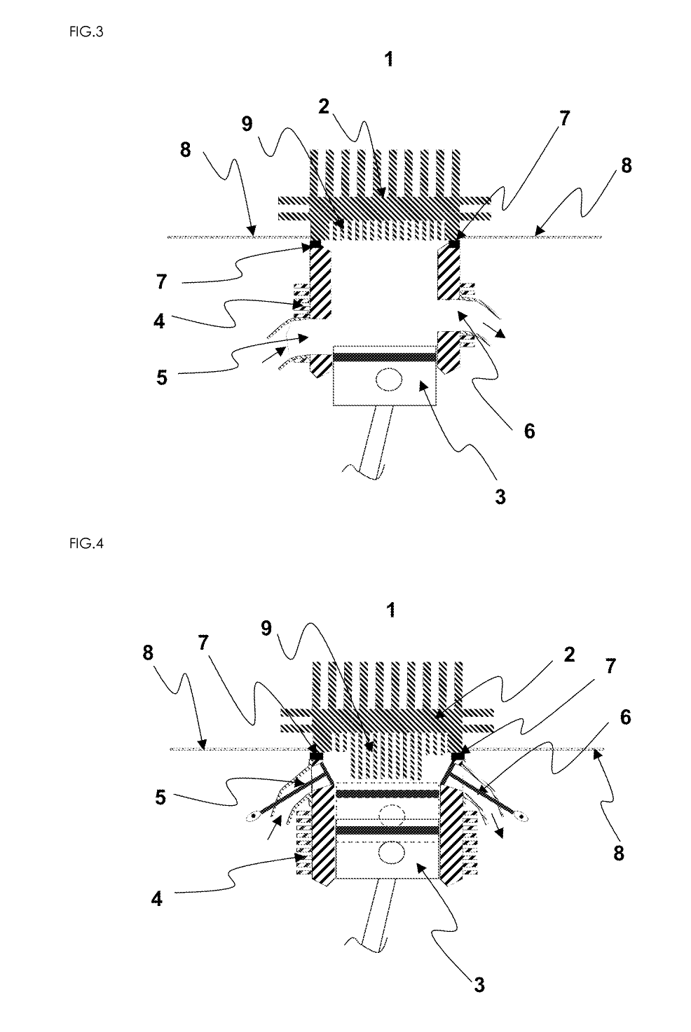

### DESCRIPTION OF THE INVENTION

The internal heat exchanger 9 located within the “dead volume” of the cylinder can use fins that are fully integrated of or attached to the heat exchanging cylinder head 2 of the engine 1. Other types of heat exchangers can be used such as microporous exchangers.

The external heat exchanger 11 immersed in the fluid of the heat source (by exchange with a fluid or by radiation) is located outside the “dead volume” of the cylinder. The heat exchange between the two exchangers (external 11 and internal 9) can be done by conduction through the material of the part 10 or with a fluid exchange between the two exchangers. It has a profile of fins or any other form for exchanging heat with the heat source. Blade profiles and fin shapes of the heat exchangers 9 and 11 of the heat exchanging cylinder head 2 will be adapted to the type of engine working compressible fluid and to the type of fluid from the heat source (liquid or steam or exhaust gases or radiation).

The engine 1, 2 or 4 stroke can have conventional valves or intake and exhaust ports commonly found in existing engines to allow the admission 5 and the exhaust 6 of the engine working fluid. The engine 1 may use a conventional splash lubrication system or under hydraulic pressure system.

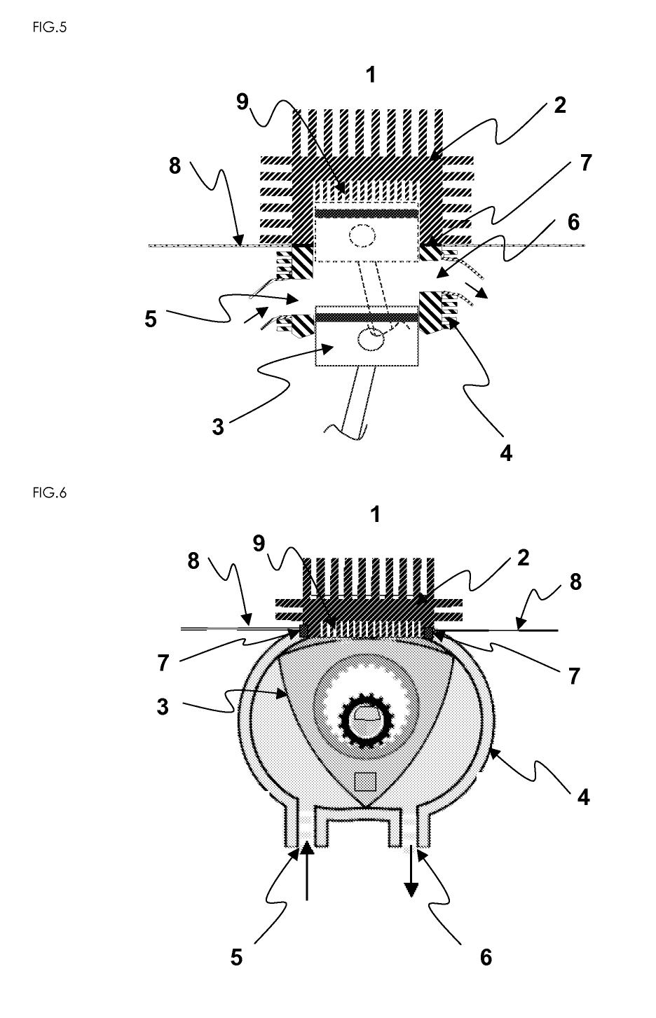

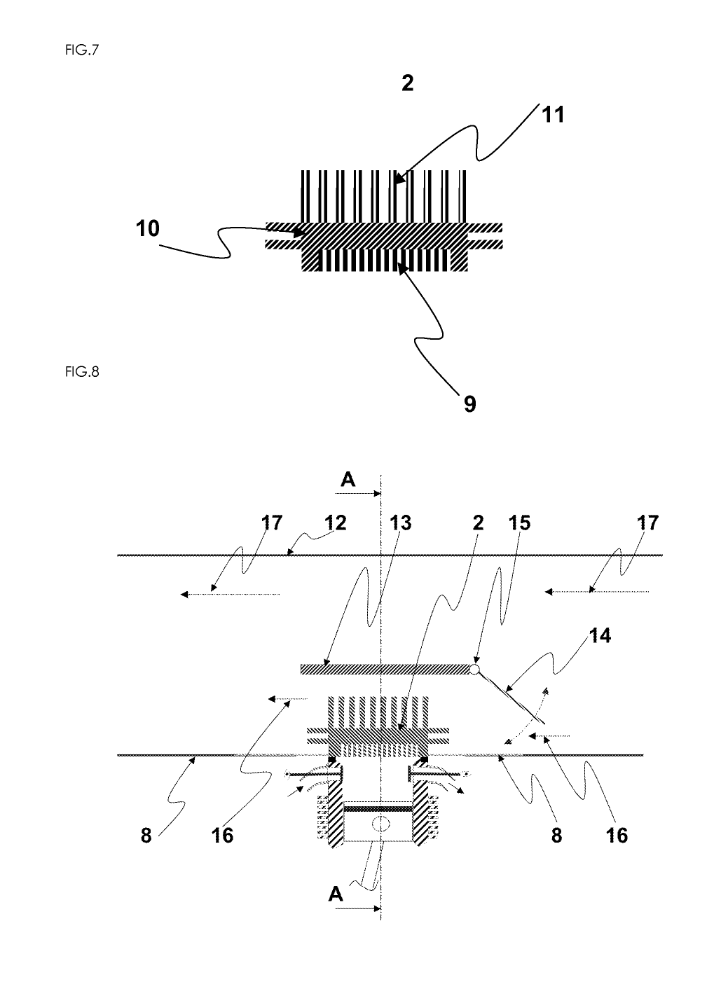

To separate the area of the hot source from the cold source, heat-insulating gasket 7 is installed between the heat exchanging cylinder head and the engine block or cylinder liner body 4 according to the type of engine to reduce the transfer of heat from the cylinder head to this body. The installation of the seal 7 will be adapted according to the type of use as necessary or not to avoid a transfer of calorie to the engine block 4, for example to avoid too high cylinder wall temperatures incompatible with the characteristics of fluid lubricant (example: oil). Under some conditions the use of refrigerant, you may want to instead keep a supply of heat to the walls to prevent too rapid condensation of the engine working fluid at the end of gas expansion. In this case, the seal 7 is not installed and a heat exchanging cylinder head 2 with wall size increased is used as shown in FIG. 5.

To improve the air filling and exhausting of the cylinder of a 2-stroke engine equipped with conventional intake port 5 and exhaust port 6 it is possible to add 1 or 2 side valves or head-mounted and integrated into the design of the heat exchanging cylinder head 2 as shown in FIG. 4. These valves will improve additional filling of fresh air of engine 1.

According to the temperature level of the heat source and as a function of the thermal constrains, the engine block 4 may be cooled by air or by fluid or may not be cooled if the temperature level of the inner wall is consistent with the level of acceptable temperature of the lubricant fluid (which may be of the oil). Depending on the level of the hot source temperature a partition wall 8 may be installed to separate the heat source of the cold source or to separate of an intermediate cooling zone the engine if the engine working fluid is separate from the cooling fluid as shown in FIG. 11 in the case of an application of a fluid refrigerant. In this case it is possible, for example to bury in the ground 20 or placing in a cold fluid (stream 20), a cooler 19 which is immersed in the cold source 20. A hydraulic or biphasic (liquid-vapor) pump 21 can be used to feed the evaporator 18 which can also be heated by radiation from which will also be transferred the vapor working fluid to engine 1 as shown in FIG. 11.

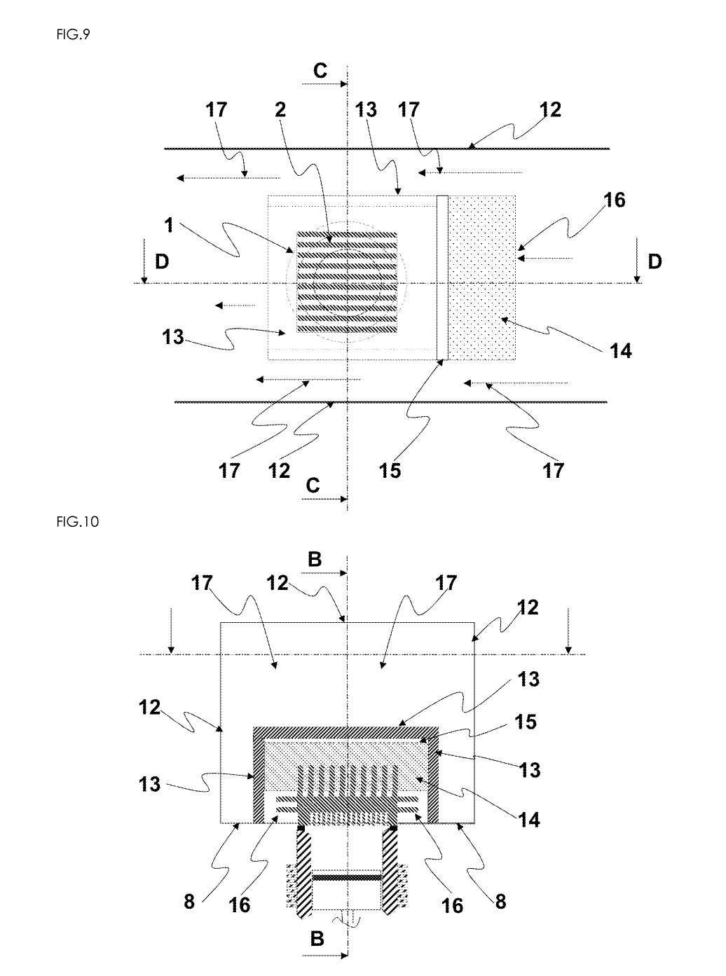

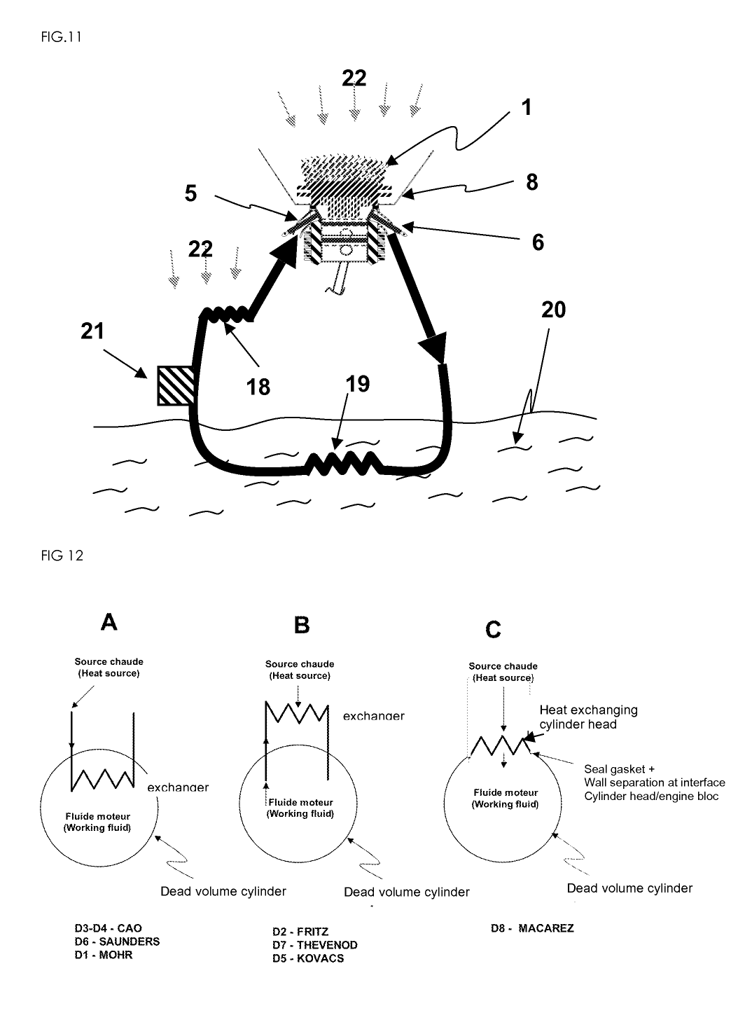

Finally a simple way to control the power of the engine 1, the present invention proposes to install a diversion or an obstruction to the passage of fluid from the heat source. This deviation may be using a movable wall 14 installed as shown in FIGS. 8-9 and 10, which can be moved by an actuator or electric or hydraulic motor. The hot fluids 17 coming from the hot heat source are totally or partially diverted to the heat exchanging cylinder head 2 to control the power of the engine 1. In FIGS. 8 to 9 and 10 only the diverted fluid 16 exchange with the heat exchanging cylinder head 2. This system uses the fixed walls 12, 13 and 8 to separate the flows 16 and 17. It thus controls the power output by controlling the flow of fluid from the heat source. Another way is to install a relief valve to vent the cylinder. Stopping the engine compression fault.

1. Thermal engine 1 operating according to a open or closed cycle such as Stirling, Ericsson or conventional, 2 or 4 strokes, using a gaseous working fluid, air or refrigerant or any fluid capable to exchange heat in the operating conditions of the engine, rejecting exhaust heat by using an external cooling exchanger 19, to a cold source which may be a fluid or a solid, and, comprising at least one conventional piston 3 or a rotary piston Wankel, at least one inlet valve or at least an inlet port 5 and at least one exhaust valve or at least an exhaust port 6, at least an engine block or cylinder liner body 4 conventional or not, in which moves the piston 3, and at least one heat exchanging cylinder head 2, whose supply of heat from a radiation which may be solar or an heat coming from a hot fluid source located outside of the engine 1 is characterized in that said heat exchanging cylinder head 2 transfers heat by conduction through a heat exchanger 11 external to the cylinder, whose walls are in contact with the hot heat source and through a heat exchanger 9 located in the cylinder, whose walls are in contact with the engine working fluid, heat exchangers 9 and 11 whom have walls that are an integral part and are part of the body of the heat exchanging cylinder head 2 itself, and characterized in that said engine 1 comprises at least one heat insulating gasket 7 installed between the heat exchanging cylinder head 2 and engine block or cylinder liner body 4, and includes at least the fixed separating walls 8, 12 and 13 installed at the level of the heat insulating gasket 7 and, it may contain a movable wall 14.

2. Thermal engine 1 according to claim 1 characterized in that the was 9 and 11 of the heat exchanging cylinder head 2 can be exchanger fins whose shape is adapted to the working fluid (fin slit) or exchanger walls microporous and fully integral part or integrally formed in the heat exchanging cylinder head 2 itself, thus forming as a whole the same one-piece part, the heat exchanging cylinder head 2, thereby allowing direct transfer of heat by conduction from the external heat source to the internal engine working fluid located inside the dead volume or located inside the engine block or cylinder liner body 4 while decreasing the levels of mechanical and thermal stresses in the walls 9 and 11, which stresses close or similar to those encountered in conventional piston engine heads, result from the pressure and temperature differential between the external heat source fluid and the internal engine working fluid, it is the body of the heat exchanging cylinder head 2 itself, which is used to conduct heat by conduction and to separate the engine working fluid and the hot heat fluid source.

3. Thermal engine 1 according to claims 1 and 2 characterized in that the heat insulating gasket 7 installed between the heat exchanging cylinder head 2 and the engine block or cylinder liner body 4 and thus reduces the heat transfer through the material of engine block or cylinder liner body 4 and limits the temperature of inner wall of the engine block or cylinder liner body 4 at a temperature compatible with the lubricant used.

4. Thermal engine 1 according to claims 1, 2 and 3, characterized in that the fixed walls separating 8, 12 and 13 are installed at the level of the heat insulating gasket 7 to separate the heat source of the cold source so that the heat radiation or heat of the fluid from the heat source does not heat the external walls of the engine block or cylinder liner body 4.

5. Thermal engine according to claims 1, 2, 3, 4 and 5, characterized in that the position of the wall 8 and the position of the heat insulating gasket 7 may be at a lower level than the level of the piston rings 3 when it is the top dead center, in order to increase the height of the heat exchanger engine head 2 and thus increase the heat exchange surfaces of the walls 9 and the exchange surfaces of the walls 11 according to the level of the temperature of the hot source, to increase the supply of heat during the compression and expansion , without increasing the stress in the exchange walls 9 and 11.

6. Thermal engine 1 according to claims 1, 2, 3, 4 and 5, characterized in that the compression ratio of the engine 1 is decreased to increase the dead volume in the engine block or cylinder liner body 4 in order to use this dead volume released to increase the heat exchange surfaces of the walls 9 integral part with the body of the heat exchanging cylinder head 2, thereby increasing technological feasibility.

7. Thermal engine according to claims 1, 2, 3, 4, 5 and 6, characterized in that the fixed separation walls 8, 12 and 13 and at least one movable wall 14 are installed to control the flow of the external heat source in contact with the walls of the exchanger 11 to control the power or the engine 1.

8. Thermal engine 1 according to claims 1, 2, 3, 4, 5, 6 and 7 using heat exchanging cylinder head 2 characterized in that when the fluid is a refrigerant, a cooler 19 is used to exchange with the cold source 20 which is a fluid or a solid.

9. Thermal engine 1 according to claims 1, 2, 3, 4, 5, 6, 7 and 8, characterized in that the refrigerant of the engine 1 uses a hydraulic or diphasic pump 21 for circulating refrigerant to the engine 1.

10 Thermal engine 1 according to claims 1, 2, 3, 4, 5, 7, 8 and 9 characterized in that the refrigerant of the heat engine 1 is vaporized in the evaporator 18, which the supply of heat can also be radiation.
